(19) United States
(12) Patent Application Publication
(10) Pub. No.: US 2018/0134252 A1
(43) Pub. Date: May 17, 2018

(54) SYSTEM FOR CONTROLLING OPERATION OF A MACHINE

(71) Applicant: Caterpillar Underground Mining Pty. Ltd., South Burnie (AU)

(72) Inventor: Noel Thomas Theodosiou, Tasmania (AU)

(73) Assignee: Caterpillar Underground Mining Pty. Ltd., South Burnie (AU)

(21) Appl. No.: 15/351,582

(22) Filed: Nov. 15, 2016

(51) Int. Cl. B60R 25/20; E05F 15/00; B60K 35/00; G07C 5/08; B60R 16/03

(52) U.S. Cl. CPC B60R 25/2036; E05F 15/00; B60R 16/03; G07C 5/0808; B60K 35/00

(57) ABSTRACT

A system for controlling operation of a machine includes a door switch that is communicably coupled to a door of the machine, a door switch control module (DCM) that is communicably coupled to the door switch, and an Electronic Control Module (ECM) that is communicably coupled to the door switch and the DCM. The door switch is configured to generate signals on the basis of the door being moved in at least one of: from an open position to a closed position, or from the closed position to the open position. The DCM monitors signals from the door switch and is configured to selectively wake-up the ECM for an amount of time in response to the door being moved in at least one of: from the open position to the closed position, or from the closed position to the open position.

### TECHNICAL FIELD

The present disclosure generally relates to a system for controlling operation of a machine. More particularly, the present disclosure relates to a system that selectively controls operation of a machine on the basis of door movements that are recorded and a state of a key switch present in the machine.

### BACKGROUND

Machines that are used in the construction field typically employ various measures in their operational schema to avoid risks to operating personnel as well as personnel located in the vicinity of such machines. For instance, U.S. Pat. No. 8,204,611 discloses a machine that includes a master electronic control module and at least one secondary electronic control module. A method for operating the machine includes the steps of: determining whether preconditions are satisfied for changing the master electronic control module from an operating state to a low power state, and determining whether preconditions are satisfied for changing the secondary electronic control module from an operating state to a power off state by opening a power supply circuit. The method also includes steps of changing the secondary electronic control module from the operating state to the power off state, and changing the master electronic control module from the operating state to the low power state.

However, manufacturers of constructional machines are nevertheless endeavoring to integrate various other types of measures in the operational schema of the machines in order to provide increased risk avoidance to the operating personnel and also to personnel located in the vicinity of such machines.

### SUMMARY OF THE DISCLOSURE

In one aspect of the present disclosure, a system for controlling operation of a machine includes a door switch that is communicably coupled to a door of the machine, a door switch control module (DCM) that is communicably coupled to the door switch, and an Electronic Control Module (ECM) that is communicably coupled to the door switch and the DCM. The door switch is configured to generate signals on the basis of the door being moved in at least one of: from an open position to a closed position, or from the closed position to the open position. The DCM monitors signals from the door switch and is configured to selectively wake-up the ECM for an amount of time in response to the door being moved in at least one of: from the open position to the closed position, or from the closed position to the open position.

In another aspect of the present disclosure, a computer-implemented method for controlling operation of a machine includes monitoring movement in a door of the machine from an open position to a closed position, and from the closed position to the open position. The method further includes selectively waking-up an Electronic Control Module (ECM) of the machine in response to the door being moved: from the open position to the closed position, and from the closed position to the open position. The method further includes maintaining the ECM in the wake-up state for an amount of time; and activating a sleep state of the ECM if no door movement is detected by the door switch within the amount of time.

In yet another aspect of the present disclosure, a non-transitory computer-readable medium is provided. The non-transitory computer-readable medium has sequences of instruction stored thereon that when executed by a computer-based system causes the computer-based system to perform operations as outlined herein. The instructions when executed by the computer based system cause the computer-based system to monitor a movement in a door of the machine i.e., movement of the door from an open position to a closed position, and from the closed position to the open position. The instructions when executed by the computer-based system also cause the computer-based system to selectively wake-up an Electronic Control Module (ECM) of the machine in response to the door being moved: from the open position to the closed position, and from the closed position to the open position; and then maintain the ECM in the wake-up state for an amount of time. Thereafter, if no door movement is detected by the door switch within the amount of time, the instructions when processed by the computer-based system cause the computer-based system to activate a sleep state of the ECM.

Other features and aspects of this disclosure will be apparent from the following description and the accompanying drawings.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an exemplary machine in which embodiments of the present disclosure can be implemented;

FIG. 2 is a schematic of a system for controlling operation of the exemplary machine of FIG. 1 in accordance with embodiments of the present disclosure;

FIG. 3 is an exemplary low level implementation of a portion of the system of FIG. 2 for controlling operation of the exemplary machine of FIG. 1 in accordance with embodiments of the present disclosure;

FIG. 4 is a block diagram of an exemplary computer-based system, according to an embodiment of the present disclosure;

FIG. 5 is a flowchart illustrating a computer implemented method for controlling operation of the exemplary machine of FIG. 1, according to an embodiment of the present disclosure; and

FIG. 6 is a low level flowchart showing steps in an exemplary implementation of the present disclosure, pursuant to the computer implemented method of FIG. 5.

FIG. 7 is a continuation of the low level flowchart of FIG. 6 showing steps in an exemplary implementation of the present disclosure, pursuant to the computer implemented method of FIG. 5.

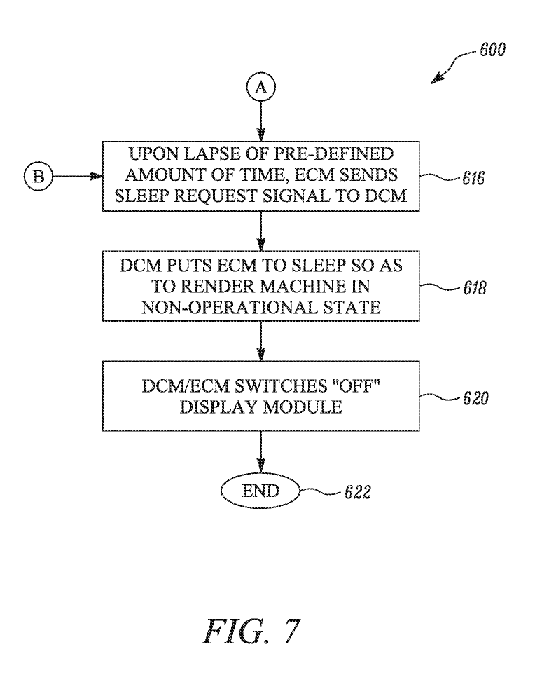

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the operating systems) may not be described in detail herein. Furthermore, the connecting lines shown in the various figures contained herein are intended to represent exemplary functional relationships and/or physical/communicative couplings between the various elements. It should be noted that many alternative or additional functional relationships or physical/communicative connections may be present in a practical system.

The present disclosure is described herein with reference to system architecture, block diagrams and flowchart illustrations of methods, and computer program products according to various aspects of the disclosure. It will be understood that each functional block of the block diagrams, the flowchart illustrations, and combinations of functional blocks in the block diagrams, the flowchart illustrations, and combinations of functional blocks in the block diagrams, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce output/s that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. It should be further appreciated that the multiple steps as illustrated and described as being combined into a single step for the sake of simplicity may be expanded into multiple steps. In other cases, steps illustrated and described as single process steps may be separated into multiple steps but have been combined for simplicity.

It may be further noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present disclosure are embodied in systems, modules, and methods for controlling operation of a machine. Specific nomenclature used herein is merely exemplary and only used for descriptive purposes. Hence, such nomenclature must not be construed as being limiting of the scope of the present disclosure.

The present disclosure is now described in more detail herein in terms of the above disclosed exemplary embodiments of system, methods, processes and computer program products. This is for convenience only and is not intended to limit the application of the present disclosure. In fact, after reading the following description, it will be apparent to one skilled in the relevant art(s) how to implement the following disclosure in alternative embodiments.

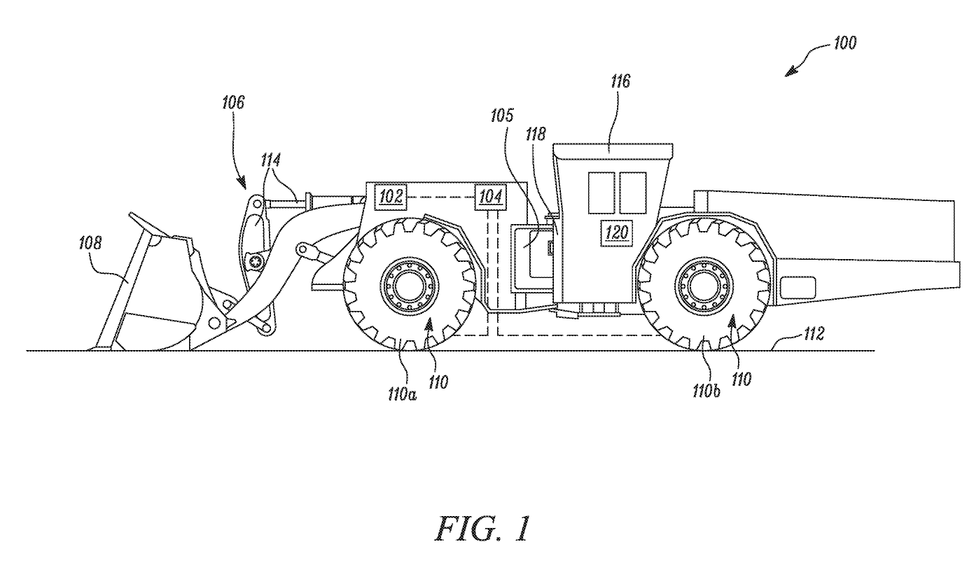

With reference to FIG. 1, an exemplary machine 100 is depicted, in which embodiments of the present disclosure may be implemented. As shown, the machine 100 is embodied in the form of a Load Haul Dumper (LHD). The machine 100 may be used in a variety of applications including mining, quarrying, road construction, construction site preparation, etc. For example, the LHD of the present disclosure may be employed for hauling earth materials such as ore, soil, debris, or other naturally occurring deposits from a worksite.

Although the exemplary machine 100 is embodied as a LHD in the illustrated embodiment of FIG. 1, it will be appreciated that the other types of machines such as, for e.g., but not limited to, shovels, diggers, buckets, hydraulic excavators, motor graders, and the like can be optionally used in lieu of the LHD disclosed herein to implement the embodiments of the present disclosure. Moreover, in alternative embodiments of the present disclosure, the machine 100 can optionally be embodied in the form of a manually operated machine, an autonomous machine, or a machine that is operable in both manual and autonomous mode. Therefore, notwithstanding any particular configuration of machine disclosed in this document, it may be noted that embodiments disclosed herein can be similarly applied to other types of machines without deviating from the spirit of the present disclosure.

As shown in FIG. 1, the machine 100 may include a drive system 102, a transmission system 104, an articulated steering system 105, an articulation system 106, a work implement 108 for e.g., a bucket, and multiple ground engaging members for e.g., wheels 110. The drive system 102 may include an engine (not shown), an electric motor for e.g., a traction motor (not shown), or both depending on specific requirements of an application. The transmission system 104 may include gears, differential systems, axles, and other components (not shown) that are coupled to the drive system 102 and the wheels 110 of the machine 100. The transmission system 104 is configured to transfer power from the drive system 102 to the wheels 110 and hence, propel the machine 100 on a work surface 112.

The articulated steering system 105 allows the wheels 110a to accomplish steering of the machine 100 relative to the wheels 110b. Moreover, the articulation system 106 disclosed herein may include linkages 114 that are coupled to the drive system 102 and the work implement 108. The articulation system 106 allows articulation of the work implement 108 during operation so that the work implement 108 can operatively perform functions such as, but not limited to, hauling and dumping materials relative to the work surface 112.

The machine 100 also includes a cab 116 having a door 118. The door 118 is configured to allow access to an operator for entering and exiting the cab 116. As such, the cab 116 is sized and shaped to house an operator of the machine 100. Moreover, the cab 116 includes control implements (not shown) that are operable for controlling a working of the machine 100. Still further, the cab 116 may include a key switch module 120 disposed therein. The key switch module 120 is operable for activating the drive system 102, the transmission system 104, the articulated steering system 105, and/or the articulation system 106 of the machine 100, and for rendering the machine 100 in an operational state subject to embodiments of the present disclosure, explanation to which will be made later in this document. In one example, the key switch module 120 can be operable, for e.g., by way of a physical key (not shown) that co-operates with the key switch module 120, or by receiving an operator input at the key switch module 120.

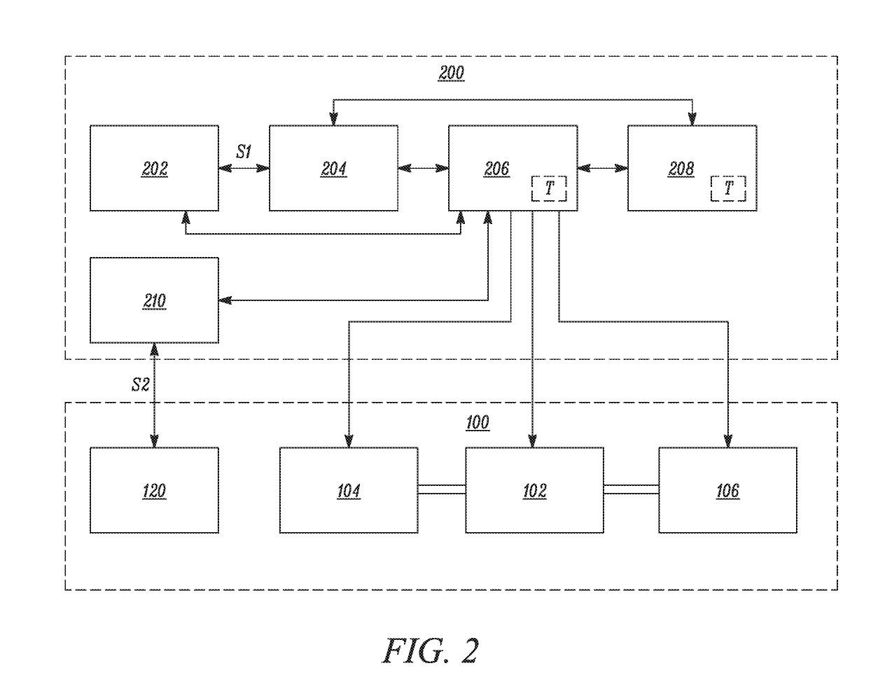

The present disclosure relates to a system 200 for controlling operation of the machine 100. Referring to FIG. 2, a schematic representation of the system 200 is illustrated. The system 200 includes a door switch 202 that is communicably coupled to the door 118 of the machine 100. The door switch 202 is configured to generate signals S1 on the basis of the door 118 being moved: from an open position to a closed position, and from the closed position to the open position. For example, if an operator moves the door 118 from the closed position to the open position for accessing the cab 116, the door switch 202 records the movement of the door 118 as being opened and generates a first signal S1 that is indicative of the door 118 being opened. In another example, upon gaining access to the cab 116, if the operator moves shuts the door 118 i.e., moves the door 118 from the open position to the closed position, the door switch 202 records the closing movement of the door 118 and accordingly generates a second signal S1 that is indicative of the door 118 being closed.

In an embodiment of this disclosure, the door switch 202 may be embodied in the form of a contact-type switch i.e., using contact with the door 118 as a means to detect movement of the door 118 from closed to open position, or open to closed position. In another embodiment, the door switch 202 may be of a non-contact type for e.g., using Hall-effect sensors for detecting movement of the door 118 from closed to open position, and open to closed position. Although a contact-type and a non-contact type switch are disclosed herein, one of ordinary skill the art can contemplate using any type of door switch 202 to perform functions that are consistent with the present disclosure. Therefore, a type and/or nature of the door switch 202 is merely exemplary in nature and hence, non-limiting of this disclosure. Any type of door switch 202 known in the art may be used without deviating from the spirit of the present disclosure.

The system 200 further includes a door switch control module (DCM) 204, and an Electronic Control Module (ECM) 206. The DCM 204 is communicably coupled to the door switch 202 while the ECM 206 is communicably coupled to the door switch 202 and the DCM 204. Further, the ECM 206 is beneficially coupled to the drive system 102, the transmission system 104, the articulated steering system 105, and the articulation system 106 of the machine 100. The DCM 204 monitors signals S1 generated by the door switch 202 as a result of the door 118 being opened or closed. The DCM 204 is further configured to selectively wake-up the ECM 206 for an amount of time T in response to the door 118 being moved from the open position to the closed position, and from the closed position to the open position. The DCM 204, disclosed herein may include various software and/or hardware components that are configured to perform functions consistent with the present disclosure. Explanation pertaining to the DCM 204 will be made later in this document.

As shown in the illustrated embodiment of FIG. 2, the system 200 further includes a display module 208 that is communicably coupled to the ECM 206. The display module 208 may be embodied in the form of one or more interfaces (not shown) allowing the operator of the machine 100 to visually, aurally, and/or haptic-ally know an operating state of the machine 100 and accordingly, control an operation of the machine 100 using such interfaces. As shown in FIG. 2, the display module 208 can also communicably coupled to the DCM 204 for executing functions that will be described later in this document.

In an embodiment of the present disclosure, the ECM 206 switches “ON” the display module 208 for the amount of time T on the basis of the door 118 being moved from the open position to the closed position. For instance, if the door 118 has been moved by the operator from the open position to the closed position after gaining access into the cab 116, the DCM 204 first wakes-up the ECM 206 which in turn may switch “ON” the display module 208. Although it is disclosed herein that the ECM 206 is configured to switch “ON” the display module 208, in an alternative embodiment of this disclosure, it can be contemplated to configure the DCM 204 in lieu of the ECM 206 to perform the function of switching “ON” the display module 208. As such, the DCM 204 is also beneficially disposed in communication with the display module 208, as shown in the illustrated embodiment of FIG. 2.

The amount of time T disclosed herein may be regarded as a maximum period of time within which at least one door movement i.e., opening or closing of the door 118 should ideally be recorded at the door switch 202 by the DCM 204. In various embodiments of the present disclosure, this pre-defined amount of time T could lie in the range of approximately 10 seconds to 5 minutes. For example, in an application, the amount of time T may be set to a minute i.e., 1 minute. In another application, the amount of time T may be set to 2 minutes. In yet another example, the amount of time T may be set to 30 seconds. However, one of ordinary skill in the art can contemplate setting the amount of time T to any value depending on specific requirements of an application without deviating from the spirit of the present disclosure.

In an embodiment of this disclosure, if no door movement is detected at the door switch 202 within the amount of time T, the ECM 206 generates a sleep request signal to the DCM 204. In response to the sleep request signal generated by the ECM 206, the DCM 204 can de-activate i.e., switch “OFF” the ECM 206 and the display module 208. As the ECM 206 is beneficially coupled to the drive system 102, the transmission system 104, the articulated steering system 105, and the articulation system 106 of the machine 100, switching “OFF” the ECM 206 can disable the drive system 102, the transmission system 104, the articulated steering system 105, and the articulation system 106 of the machine 100 and hence, render the machine 100 in a non-operational state.

As shown in the illustrated embodiment of FIG. 2, the system 200 further includes a key switch 210 that is communicably coupled to the ECM 206 and the key switch module 120 of the machine 100. The ECM 206 is configured to receive a key input signal S2 from the key switch 210 upon actuation of the key switch module 120 for e.g., when the key switch module 120 is turned “ON” or “OFF” with the help of a physical key (not shown), or when the key switch module 120 receives an operator input.

In an embodiment, the ECM 206 further performs diagnostic functions on the DCM 204 and the door switch 202 in response to the door 118 being currently disposed in the closed position as determined by the ECM 206; and upon receipt of a key input signal S2 that is indicative of the key switch module 120 being turned “ON”. The diagnostic functions disclosed herein can be regarded as including functions such as, but limited to, monitoring integrity of the door switch 202 and the DCM 204. For example, if the door switch 202 or the DCM 204 has been tampered with so as to cause any hindrance to an operational regime of the door switch 202 and/or the DCM 204, then the ECM 206 can record such instances to disable the drive system 102, the transmission system 104, the articulated steering system 105, and/or the articulation system 106 of machine 100 and hence, render the machine 100 in a non-operational state. As such, the ECM 206 is configured to allow machine movement in response to the door 118 being currently disposed in the closed position (as determined by the ECM 206); and upon receipt of a key input signal S2 that is indicative of the key switch module 120 being turned “ON”.

However, if the door switch 202 generates a signal S1 indicative of the door 118 being in the open position and the key input signal S2 from the key switch 210 is indicative of the key switch module 120 being turned “ON”, then the ECM 206 disables the drive system 102, the transmission system 104, the articulated steering system 105, and/or the articulation system 106 of the machine 100 so as to render the machine 100 in a non-operational state. Therefore, in various embodiments of the present disclosure, the ECM 206 prevents the operator from operating the machine 100 (i.e., by disabling the drive system 102, the transmission system 104, the articulated steering system 105, and the articulation system 106 of the machine 100) when the door 118 is left open and the key switch module 120 is turned “ON”. As disclosed earlier herein, the open position of the door 118 can be determined by the ECM 206 from the signal S1 generated at the door switch 202, and the “ON” state of the key switch module 120 can be determined from the key input signal S2 generated by the key switch 210.

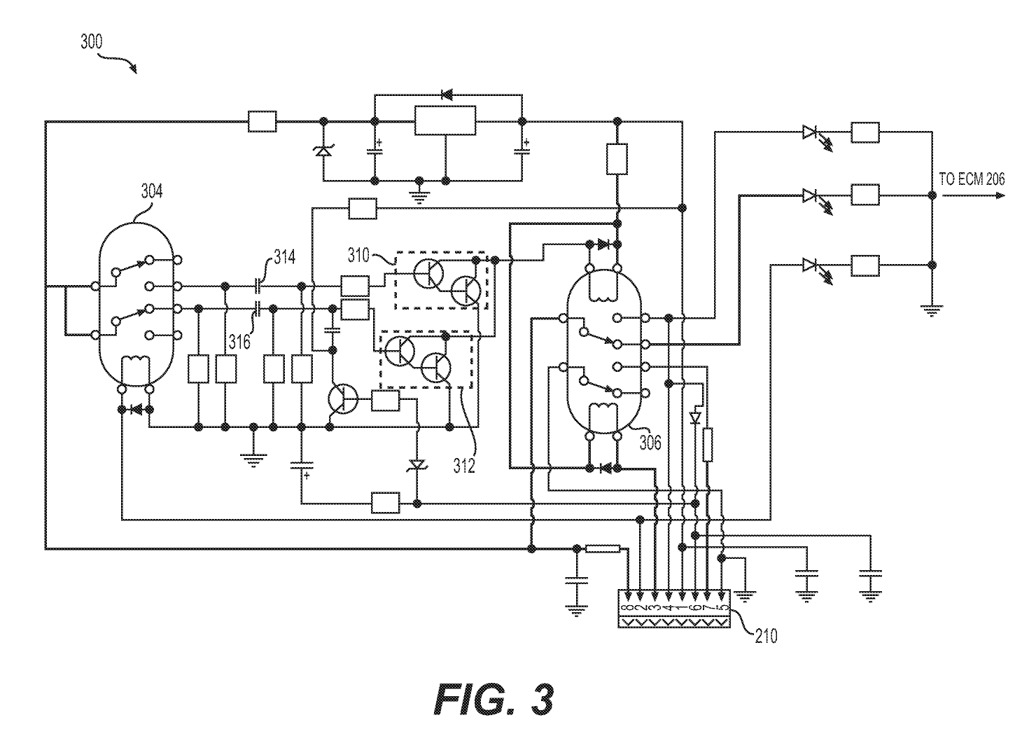

FIG. 3 is an exemplary low level implementation 300 of a portion of the system 200 of FIG. 2 for controlling operation of the exemplary machine 100 of FIG. 1 in accordance with embodiments of the present disclosure. For the sake of simplicity in this document, the low level implementation 300 of a portion of the system 200 will hereinafter be referred to as ‘the system’ and designated with identical reference numeral ‘300’). Referring to the system 300 of FIG. 3, the system 300 includes a first relay 304, a second relay 306, and a pair of Darlington transistors 310, 312. The system 300 also includes a first capacitor 314 and a second capacitor 316. The first capacitor 314 is located between the first relay 304 and a first Darlington transistor 310 while the second capacitor 316 is located between the first relay 304 and a second Darlington transistor 312. Moreover, the first capacitor 314 and the first Darlington transistor 310 are disposed in parallel to the second capacitor 316 and the second Darlington transistor 312 respectively. The system 300 as disclosed in FIG. 3 may include various additional components other than illustrated and described above, and explanation to such additional components has been willfully omitted for the sake of brevity in this document, and also for the sake of simplicity in understanding the present disclosure.

Although not shown in FIG. 3, the system 300 may include and be in operable communication with the door switch 202. During operation, the door switch 202 generates a signal S1 indicative of the door 118 being in the open position or in the closed position. If the door 118 is in the closed position, then the door switch 202 energizes the first relay 304 so as to take up a first operational state. When in the first operational state, pulse voltage from the first relay 304 may be communicated to the first Darlington transistor 310 via the first capacitor 314 and subsequently to the second relay 306 so as to position the second relay 306 in the first operational state i.e., a wake-up state. The second relay 306 in turn wakes-up the ECM 206. Alternatively, when the door 118 has been moved into the closed position, the first relay 304 could communicate the pulse voltage to the second Darlington transistor 312 via the second capacitor 316 and subsequently to the second relay 306 so as to position the second relay 306 in the first operational state i.e., a wake-up state.

However, if the door 118 is in the open position and has been left un-attended for the amount of time T (i.e., no further door movement has been recorded at the door switch 202 for the amount of time T), or if there has been no actuation of the key switch module 120 within the amount of time T (i.e., no key input signal S2 from the key switch 210 within the amount of time T), then the ECM 206 (See FIG. 2) latches the second relay 306 into a second operational state i.e., a sleep mode. The second relay 306 can then cause a sleep mode to be implemented at the ECM 206.

The present disclosure has been described herein in terms of functional block components, modules, and various processing steps. It should be appreciated that such functional blocks may be realized by any number of hardware and/or software components configured to perform the specified functions. For example, system 200 may employ various integrated circuit components, e.g., memory elements, processing elements, logic elements, look-up tables, and/or the like, which may carry out a variety of functions under the control of one or more microprocessors or other control devices. Similarly, the software elements of the system 200 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system 200 may employ any number of conventional techniques for data transmission, signaling, data processing, network control, and/or the like. Still further, the system 200 could be configured to detect or prevent security issues with a user-side scripting language, such as JavaScript, VBScript or the like. In an embodiment of the present disclosure, the networking architecture between components of the system 200, for e.g., between the DCM 204 and the ECM 206 of system 200 may be implemented by way of a client-server architecture. In an embodiment of the present disclosure, the client-server architecture may be built on a customizable.Net (dot-Net) platform. However, it may be apparent to a person ordinarily skilled in the art that various other software frameworks may be utilized to build the client-server architecture between components of the system 200 for e.g., between the DCM 204 and the ECM 206 without departing from the spirit and scope of the disclosure.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce instructions which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present disclosure (i.e., the system 200, method 500, any part(s) or function(s) thereof) may be implemented using hardware, software or a combination thereof, and may be implemented in one or more computer systems or other processing systems. However, the manipulations performed by the present disclosure were often referred to in terms such as monitoring, detecting, determining, comparing, or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

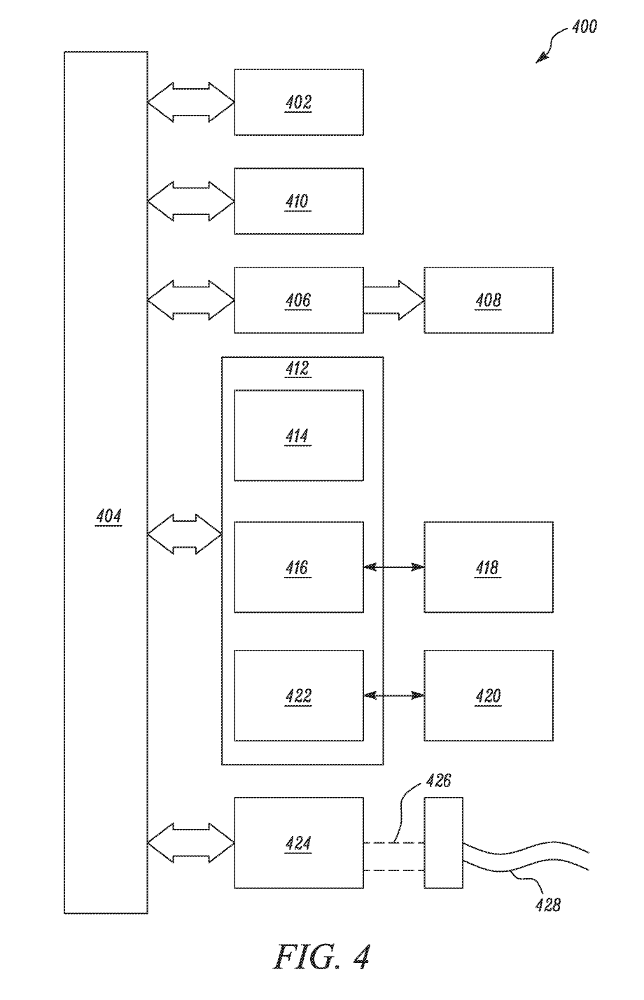

In fact, in accordance with an embodiment of the present disclosure, the present disclosure is directed towards one or more computer systems capable of carrying out the functionality described herein. An example of the computer-based system includes a computer system 400, which is shown by way of a block diagram in FIG. 4.

Computer system 400 includes at least one processor, such as a processor 402. Processor 402 may be connected to a communication infrastructure 404, for example, a communications bus, a cross-over bar, a network, and the like. Various software embodiments are described in terms of this exemplary computer system 400. Upon perusal of the present description, it will become apparent to a person skilled in the relevant art(s) how to implement the present disclosure using other computer systems and/or architectures.

Computer system 400 includes a display interface 406 that forwards graphics, text, and other data from communication infrastructure 404 for display on a display unit 408.

Computer system 400 further includes a main memory 410, such as random access memory (RAM), and may also include a secondary memory 412. Secondary memory 412 may further include, for example, a hard disk drive 414 and/or a removable storage drive 416, representing a floppy disk drive, a magnetic tape drive, an optical disk drive, etc. Removable storage drive 416 reads from and/or writes to a removable storage unit 418 in a well-known manner. Removable storage unit 418 may represent a floppy disk, magnetic tape or an optical disk, and may be read by and written to by removable storage drive 416. As will be appreciated, removable storage unit 418 includes a computer usable storage medium having stored therein, computer software and/or data.

In accordance with various embodiments of the present disclosure, secondary memory 412 may include other similar devices for allowing computer programs or other instructions to be loaded into computer system 400. Such devices may include, for example, a removable storage unit 420, and an interface 422. Examples of such may include a program cartridge and cartridge interface (such as that found in video game devices), a removable memory chip (such as an erasable programmable read only memory (EPROM), or programmable read only memory (PROM)) and associated socket, and other removable storage units 420 and interfaces 422, which allow software and data to be transferred from removable storage unit 420 to computer system 400.

Computer system 400 may further include a communication interface 424. Communication interface 424 allows software and data to be transferred between computer system 400 and external devices. Examples of communication interface 424 include, but may not be limited to a modem, a network interface (such as an Ethernet card), a communications port, a Personal Computer Memory Card International Association (PCMCIA) slot and card, and the like. Software and data transferred via communication interface 424 may be in the form of a plurality of signals, hereinafter referred to as signals 426, which may be electronic, electromagnetic, optical or other signals capable of being received by communication interface 424. Signals 426 may be provided to communication interface 424 via a communication path (e.g., channel) 428. Communication path 428 carries signals 426 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 416, a hard disk installed in hard disk drive 414, signals 426, and the like. These computer program products provide software to computer system 400. The present disclosure is directed to such computer program products.

Computer programs (also referred to as computer control logic) may be stored in main memory 410 and/or secondary memory 412. Computer programs may also be received via the communication interface 404. Such computer programs, when executed, enable computer system 400 to perform the functions consistent with the present disclosure, as discussed herein. In particular, the computer programs, when executed, enable processor 402 to perform the features of the present disclosure. Accordingly, such computer programs represent controllers of computer system 400.

In accordance with an embodiment of the present disclosure, where the disclosure is implemented using a software, the software may be stored in a computer program product and loaded into computer system 400 using removable storage drive 416, hard disk drive 414 or communication interface 424. The control logic (software), when executed by processor 402, causes processor 402 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

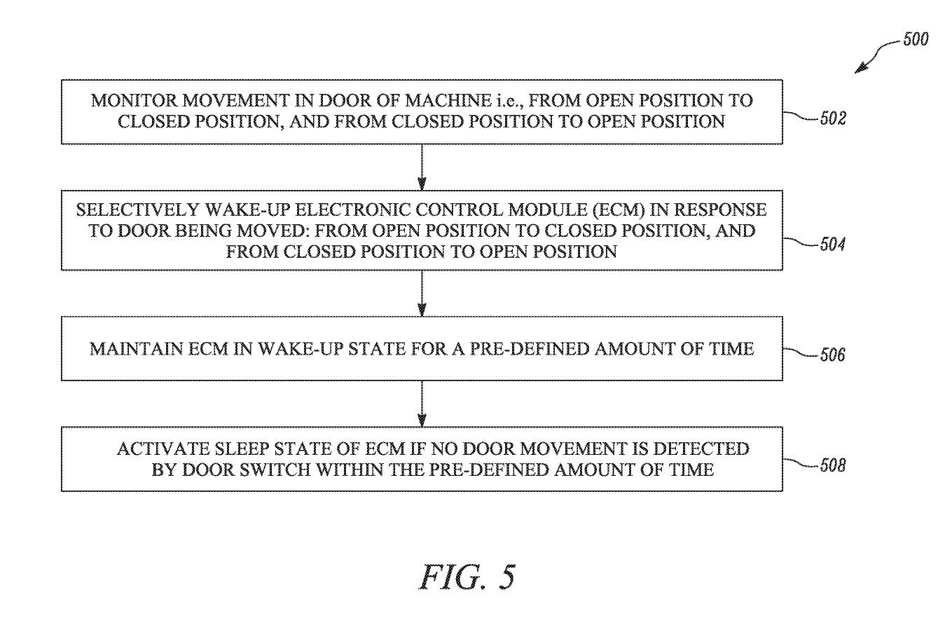

FIG. 5 is a flowchart illustrating a computer implemented method 500 for controlling operation of the exemplary machine 100, according to an embodiment of the present disclosure.

At step 502, the method 500 includes monitoring movement in the door 118 of the machine 100 from the open position to the closed position, and from the closed position to the open position. At step 504, the method 500 further includes selectively waking-up the Electronic Control Module (ECM) 206 in response to the door 118 being moved from the open position to the closed position, or from the closed position to the open position. At step 506, the method 500 further includes maintaining the ECM 206 in the wake-up state for an amount of time T. At step 508, the method 500 further includes activating a sleep state of the ECM 206 if no door movement is detected by the door switch 202 within the amount of time T. As disclosed earlier herein, in various embodiments, the amount of time T can lie in the range of approximately 10 seconds to 5 minutes. For example, in an application, the amount of time T could be set to 2 minutes. However, as disclosed earlier herein, the amount of time T could be set to any value depending on specific requirements of an application.

In an aspect of the present disclosure, the method 500 further includes selectively switching “ON” the display module 208 of the machine 100 for the amount of time T on the basis of the door 118 being moved from the open position to the closed position.

In another aspect of the present disclosure, the method 500 further includes receiving the key input signal S2 from the key switch 210 upon actuation of the key switch module 120 of the machine 100 at the ECM 206.

If the door 118 is currently disposed in the closed position, as determined by the DCM 204; and if the key switch 210 generates a key input signal S2 that is indicative of the key switch module 120 being turned “ON” to the ECM 206, then the ECM 206 allows movement of the machine 100 i.e., allows movement or operation of the drive system 102, the transmission system 104, the articulated steering system 105, and the articulation system 106. Moreover, the ECM 206 proceeds to perform diagnostic functions on the DCM 204 and the door switch 202 to verify or determine the integrity of the DCM 204 and the door switch 202. As disclosed earlier herein, diagnostic functions could include checking whether the door switch 202 or the DCM 204 has been tampered with so as to cause hindrance in the operation of the door switch 202 or the DCM 204, or to cause inadvertent or incorrect operation of the machine 100 itself.

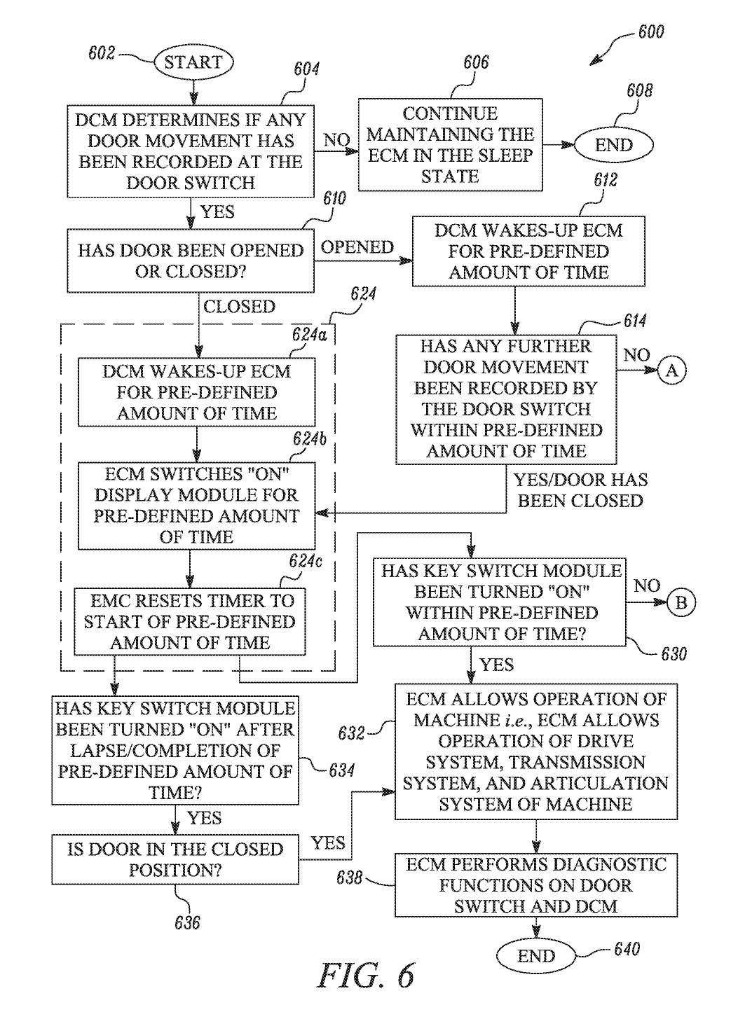

FIG. 6 illustrates a low level process flowchart 600 showing steps 602-640 in an exemplary implementation of the present disclosure, pursuant to the method 500 of FIG. 5. As such, the process flowchart 600 of FIG. 6 also outlines the logic flow with which the system 200 of the present disclosure can operate for controlling operation of the machine 100. However, while explaining the process 600 illustrated in FIG. 6, some aspects of the foregoing disclosure may be recapitulated or omitted for the purposes of better understanding of the present disclosure or for the sake of brevity in the present document. However, it should be noted that such explanation should not be construed as being limiting of this disclosure, rather the explanation pertaining to FIG. 6 should be taken merely in the illustrative and explanatory sense only. The exact scope of the present disclosure is defined by the claims appended herein.

Referring to FIG. 6, the process 600 is shown to initiate with a start step 602. At step 604, the DCM 204 determines if any movement of the door 118 has been detected by the door switch 202. If no door movement has been detected, the process 600 proceeds to step 606 where the DCM 204 continues to maintain the ECM 206 in the sleep state. Thereafter, the process 600 terminates at step 608.

However, if at step 604, the DCM 204 determines that door movement has been detected by the door switch 202, then the process 600 proceeds to step 610 where the DCM 204 further determines from the door switch 202 whether the door 118 has been opened or closed. If the door 118 has been opened, then the process 600 proceeds to step 612 where the DCM 204 wakes-up the ECM 206 for the amount of time T. Thereafter, the process 600 proceeds to step 614, where the DCM 204 determines if any further door movement has been recorded at the door switch 202 within the amount of time T. At step 614, if door movement has been detected within the amount of time T i.e., if the door 118 has been closed within the amount of time T, then the process 600 proceeds to step 624b where the ECM 206 switches “ON” the display module 208 for the amount of time T. Moreover, as shown at step 624c, the ECM 206 also resets its timer to a start of the amount of time T i.e., at 0 seconds of the amount of time T or no lapse of time from within the amount of time T.

However, if at step 610, the DCM 204 has determined that the door switch 202 has recorded a door movement from open to closed position, then the process 600 directly proceeds from step 610 to step 624a in which the DCM 204 wakes-up the ECM 206 for the amount of time T, while the ECM 206 switches “ON” the display module 208 for the amount of time T (see step 624b). As shown at step 624c, the ECM 206 also resets its timer to a start of the amount of time T i.e., at 0 seconds of the amount of time T or no lapse of time from within the amount of time T. In various aspects of the present disclosure, it should be noted that the steps 624a, 624b, and 624c may occur in a substantially simultaneous manner or in a tandem manner without limiting the scope of the present disclosure.

The process 600 then proceeds from step 624c to step 630 in which the ECM 206 makes a determination as to whether the key switch module 120 has been turned “ON” within the amount of time T. If the key switch module 120 has been turned “ON” within the amount of time T, then the process 600 proceeds to step 632 in which the ECM 206 allows an operation of the machine 100, i.e., the ECM 206 allows operation of the drive system 102, the transmission system 104, the articulated steering system 105, and the articulation system 106 of the machine 100. Moreover, the process 600 further proceeds to step 638 wherein the ECM 206 performs diagnostic functions on the door switch 202 and the DCM 204. For example, the ECM 206 may perform diagnostic functions on the door switch 202 and the DCM 204 to check or verify the integrity of the door switch 202 and the DCM 204. The process 600 then terminates at step 640.

In an embodiment, if at step 630, the key switch module 120 has not been turned on within the amount of time T, then the proceeds from step 630 to step 616 wherein the ECM 206 sends a sleep request signal to the DCM 204. Upon receipt of the sleep request signal by the DCM 204 at step 618, the DCM 204 puts the ECM 206 in a sleep state so as to render the machine 100 non-operational. Moreover, as shown at step 620, the DCM 204 or the ECM 206 switches “OFF” the display module 208. The process 600 then terminates at step 622.

Alternatively, if the key switch module 120 has been turned “ON” after a lapse/completion of the amount of time T as shown at step 634, then the process 600 could proceed to step 636 in which the DCM 204 further determines if the door 118 has been closed. It can be assumed that at this point, the ECM 206 is in a sleep state upon completion of the amount of time T. Moreover, as the DCM 204 monitors signals S1 from the door switch 202 (that are indicative of the closing and opening of the door 118), if the door movement last recorded at the door switch 202 is that of the door 118 being closed, then the DCM 204 receives the signal S1 indicative of the door 118 closure from the door switch 202 and wakes-up the ECM 206. Thereafter, the ECM 206 allows an operation of the machine 100 as shown at step 632, i.e., the ECM 206 allows operation of the drive system 102, the transmission system 104, the articulated steering system 105, and the articulation system 106 of the machine 100. The process 600 then proceeds to step 638 wherein the ECM 206 performs diagnostic functions on the door switch 202 and the DCM 204. For example, the ECM 206 may perform diagnostic functions on the door switch 202 and the DCM 204 to check or verify the integrity of the door switch 202 and the DCM 204. The process 600 then terminates at step 640.

Embodiments of the present disclosure have applicability for use and implementation in controlling an operation of a machine. It has been seen that in many cases, operators of machines may sometimes inadvertently operate the machine with the door of the machine being left in the open position. In some other cases, personnel located in the vicinity of the machine, for e.g., near the articulation hitch area of load haul dumpers, may open the door when the machine is in an operating state. Such instances may pose a risk to the operating personnel and/or the personnel located in the vicinity of the machine. However, with implementation of the system 200 disclosed herein, the machine may be disabled with immediate effect upon detecting that the door is in the open position.

Moreover, operators may sometimes tamper with the door switch for the sake of convenience thereby overriding protocols or measures. In such cases, the system 200 of the present disclosure also performs diagnostic functions on the door switch to ensure that any tampering of the door switch is detected and that machine operation is immediately disabled. Therefore, with use of embodiments disclosed herein, operators are prevented from operating the machine when there is a risk to the operating personnel as well as personnel located in the vicinity of the machine. Use of embodiments disclosed herein can thus help operators to ensure that risk avoidance measures are adhered to when operating the machine in a worksite.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for controlling operation of a machine, the system comprising:
a door switch communicably coupled to a door of the machine, the door switch configured to generate signals on the basis of the door being moved: from at least one of an open position to a closed position or from the closed position to the open position;
a door switch control module (DCM) communicably coupled to the door switch, the DCM configured to monitor signals from the door switch; and
an Electronic Control Module (ECM) communicably coupled to the door switch and the DCM, wherein the DCM is configured to selectively wake-up the ECM for an amount of time in response to the door being moved from: at least one of the open position to the closed position or from the closed position to the open position.

2. The system of claim 1 further comprising a display module communicably coupled to the ECM.

3. The system of claim 2, wherein the ECM switches “ON” the display module for the amount of time on the basis of the door being moved from the open position to the closed position.

4. The system of claim 3, wherein the amount of time is in the range of approximately 10 seconds to 5 minutes.

5. The system of claim 3, wherein the ECM is configured to generate a sleep request signal to the DCM if no door movement is detected at the door switch within the amount of time.

6. The system of claim 5, wherein the DCM is further configured to de-activate the ECM and switch “OFF” the display module in response to the sleep request signal generated by the ECM.

7. The system of claim 1 further comprising a key switch communicably coupled to the ECM and a key switch module of the machine, wherein the ECM is configured to receive a key input signal from the key switch upon actuation of the key switch module.

8. The system of claim 7, wherein the ECM is further configured to perform diagnostic functions on the DCM and the door switch in response to:
the door being currently disposed in the closed position as determined by the ECM; and
upon receipt of a key input signal that is indicative of the key switch module being turned “ON”.

9. The system of claim 7, wherein the ECM is further configured to allow machine movement in response to:
the door being currently disposed in the closed position as determined by the ECM; and
upon receipt of a key input signal that is indicative of the key switch module being turned “ON”.

10. A computer-implemented method for controlling operation of a machine, the method comprising:
monitoring movement in a door of the machine from an open position to a closed position, and from the closed position to the open position;
selectively waking-up an Electronic Control Module (ECM) in response to the door being moved in at least one of: from the open position to the closed position, or from the closed position to the open position;
maintaining the ECM in the wake-up state for an amount of time; and
activating a sleep state of the ECM if no door movement is detected by the door switch within the amount of time.

11. The computer-implemented method of claim 10 further comprising selectively switching “ON” a display module of the machine for the amount of time on the basis of the door being moved from the open position to the closed position.

12. The computer-implemented method of claim 11, wherein the amount of time is in the range of approximately 10 seconds to 5 minutes.

13. The computer-implemented method of claim 10 further comprising receiving, at the ECM, a key input signal from a key switch upon actuation of a key switch module of the machine.

14. The computer-implemented method of claim 13 further comprising performing diagnostic functions, by the ECM on the door switch and a door switch control module (DCM) communicably coupled to the door switch, in response to:
the door being currently disposed in the closed position as determined by the ECM; and
upon receipt of a key input signal that is indicative of the key switch module being turned “ON”.

15. The computer-implemented method of claim 13 further comprising allowing movement of the machine, by the ECM, in response to:
the door being currently disposed in the closed position as determined by the ECM; and
upon receipt of a key input signal that is indicative of the key switch module being turned “ON”.

16. A non-transitory computer-readable medium having stored thereon sequences of instruction, the sequences of instruction including instruction which when executed by a computer-based system for controlling operation of a machine, causes the computer-based system to perform operations, comprising:
monitoring movement of a door of the machine, by the computer-based system, in at least one of: from an open position to a closed position, or from the closed position to the open position;
selectively waking-up an Electronic Control Module (ECM) of the machine, by the computer-based system, in response to the door being moved in at least one of: from the open position to the closed position, and from the closed position to the open position; and
maintaining the ECM in the wake-up state, by the computer-based system, for an amount of time; and
activating a sleep state of the ECM if no door movement is detected by the door switch within the amount of time.

17. The non-transitory computer-readable medium of claim 16 further comprising selectively switching “ON” a display module of the machine for the amount of time on the basis of the door being moved from the open position to the closed position.

18. The non-transitory computer-readable of claim 16 further comprising receiving, at the ECM, a key input signal from a key switch upon actuation of a key switch module of the machine.

19. The non-transitory computer-readable of claim 18 further comprising performing diagnostic functions, by the ECM on the door switch and a door switch control module (DCM) communicably coupled to the door switch, in response to:
the door being currently disposed in the closed position as determined by the ECM; and
upon receipt of a key input signal that is indicative of the key switch module being turned “ON”.

20. The non-transitory computer-readable of claim 18 further comprising allowing movement of the machine, by the ECM, in response to:
the door being currently disposed in the closed position as determined by the ECM; and
upon receipt of a key input signal that is indicative of the key switch being turned “ON”.
